(19) United States
(12) Patent Application Publication
(10) Pub. No.: US 2025/0238020 A1
(43) Pub. Date: Jul. 24, 2025

(54) ABNORMALITY DIAGNOSTIC DEVICE, ABNORMALITY DIAGNOSTIC SYSTEM, AND STORAGE MEDIUM

(71) Applicant: FANUC CORPORATION, Yamanashi (JP)

(72) Inventors: Liancheng HU, Yamanashi (JP); Kazuhiro SATOU, Yamanashi (JP)

(21) Appl. No.: 18/704,455

(22) PCT Filed: Nov. 19, 2021
(86) PCT No.: PCT/JP2021/042610

§ 371 Date: Apr. 25, 2024

(51) Int. Cl. G05B 19/418

(52) U.S. Cl. CPC G05B 19/4184

(57) ABSTRACT

This abnormality diagnostic device for diagnosing an abnormality that occurs in a factory acquires data to be used for detecting an abnormality that occurs in a factory, detects an abnormality of a subject of diagnosis by using the data to be used for detecting an abnormality, reports the detected abnormality, acquires data to be used for analyzing an abnormality, and analyzes a candidate abnormality cause by using the data to be used for analyzing an abnormality in a period including a time point at which the abnormality has occurred, or by using the data to be used for analyzing an abnormality and the data to be used for detecting an abnormality in a period including a time point at which the abnormality has been detected.

### RELATED APPLICATIONS

The present application is a National Phase of International Application No. PCT/JP2021/042610 filed Nov. 19, 2021.

### TECHNICAL FIELD

The present invention relates to an anomaly diagnosis device, an anomaly diagnosis system, and a storage medium.

### BACKGROUND ART

In production lines in factories, only a single malfunction may affect the overall processes. To maintain high availability, it is necessary to detect predictive signs in order to prevent anomalies or issues in a factory facility.

In case of suspension of a production line occurred for some trouble, it is required to identify the factor as soon as possible and quickly resolve the problem.

Conventionally, in an anomaly factor identifying device that identifies the factor of an anomaly occurring in a machine, a technology is known that is to acquire a sensor signal related to the physical state of a machine, determine the operation status of the machine based on information acquired from the machine, calculate the degree of abnormality of the sensor signal for each operation status of the machine, and diagnose the factor of the anomaly in the machine from history data that is a sequence of degrees of abnormality for each operation status. For example, see Patent Literature 1.

In the anomaly factor identifying device described in Patent Literature 1, an indication of an anomaly is detected based on signals from a sensor, and a signal in which occurrence of an anomaly can be identified is extracted to identify the factor of the anomaly. The identified result is stored in a memory, and the site of the anomaly or the type of the anomaly is diagnosed.

### CITATION LIST

### Patent Literature

Patent Literature 1: Japanese Patent Application Laid-Open No. 2019-148971

### SUMMARY OF INVENTION

### Technical Problem

In diagnosis of an anomaly, a computational load and diagnostic accuracy have a conflicting relationship. Increased diagnostic accuracy will increase the computational load, and when it is intended to reduce the computational load, it is required to adjust diagnostic accuracy.

In the field of anomaly diagnosis in manufacturing industries, a technology to suppress the computational load while ensuring diagnostic accuracy is desired.

### Solution to Problem

The anomaly diagnosis device that is one aspect of the present disclosure is an anomaly diagnosis device that diagnoses an anomaly occurring in a factory, and the anomaly diagnosis device includes: an anomaly detection data acquisition unit that acquires data to be used for anomaly detection; an anomaly detection unit that uses the data acquired by the anomaly detection data acquisition unit to detect an anomaly to be diagnosed; an anomaly notification unit that notifies the anomaly detected by the anomaly detection unit; an anomaly analysis data acquisition unit that acquires data to be used for anomaly analysis; and an anomaly analysis unit that uses the data to be used for the anomaly analysis obtained in a period including a time of occurrence of the anomaly or uses the data to be used for the anomaly detection and the data to be used for the anomaly analysis obtained in a period including a time of detection of the anomaly to analyze a candidate factor of the anomaly.

The anomaly diagnosis system that is one aspect of the present disclosure is an anomaly diagnosis system that diagnoses an anomaly occurring in a factory, and the anomaly diagnosis system includes: an anomaly detection data acquisition unit that acquires data to be used for anomaly detection; an anomaly detection unit that uses the data acquired by the anomaly detection data acquisition unit to detect an anomaly to be diagnosed; an anomaly notification unit that notifies the anomaly detected by the anomaly detection unit; an anomaly analysis data acquisition unit that acquires data to be used for anomaly analysis; and an anomaly analysis unit that uses the data to be used for the anomaly analysis obtained in a period including a time of occurrence of the anomaly or uses the data to be used for the anomaly detection and the data to be used for the anomaly analysis obtained in a period including a time of detection of the anomaly to analyze a candidate factor of the anomaly.

The computer readable storage medium that is one aspect of the present disclosure stores a computer readable instruction that causes one or a plurality of processors to: acquire data to be used for anomaly detection for an anomaly occurring in a factory; use the data to be used for anomaly detection to detect an anomaly to be diagnosed based on a model used for anomaly detection; notify the detected anomaly; acquire data to be used for anomaly analysis; and use the data to be used for the anomaly analysis obtained in a period including a time of occurrence of the anomaly or uses the data to be used for the anomaly detection and the data to be used for the anomaly analysis obtained in a period including a time of detection of the anomaly to analyze a candidate factor of the anomaly.

### Advantageous Effects of Invention

According to one aspect of the present invention, it is possible to suppress the computational load while ensuring diagnostic accuracy in anomaly diagnosis of a machine.

### BRIEF DESCRIPTION OF DRAWINGS

FIG. 1 is a hardware configuration diagram of an anomaly diagnosis device.

FIG. 2 is a block diagram of an anomaly diagnosis device of the first disclosure.

FIG. 3 illustrates an example of a selection window for anomaly detection conditions.

FIG. 4 is a diagram illustrating a difference in the data quantity between a case of prioritizing accuracy and a case of prioritizing speed.

FIG. 5 illustrates an example of an anomaly notification window.

FIG. 6 is a diagram illustrating an example of extraction of data used for anomaly detection.

FIG. 7 diagram illustrating an example of extraction of data used for anomaly analysis.

FIG. 8 illustrates an example of a display window for an analysis result.

FIG. 9 illustrates an example of a selection window for anomaly analysis conditions.

FIG. 10 is a flowchart illustrating an operation of the anomaly diagnosis device.

FIG. 11 is a diagram illustrating an anomaly diagnosis system of the second disclosure.

### DESCRIPTION OF EMBODIMENTS

### First Disclosure

An anomaly diagnosis device 100 detects and diagnoses an anomaly of a factory, machinery in a factory or a facility, or products manufactured in a factory. The anomaly diagnosis device 100 may be installed on a numerical control device, a programmable logic controller (PLC), a server, a personal computer, or the like, each of which is an information processing device in a factory, or the components of the anomaly diagnosis device 100 may be arranged distributed in a factory system as illustrated in the second disclosure.

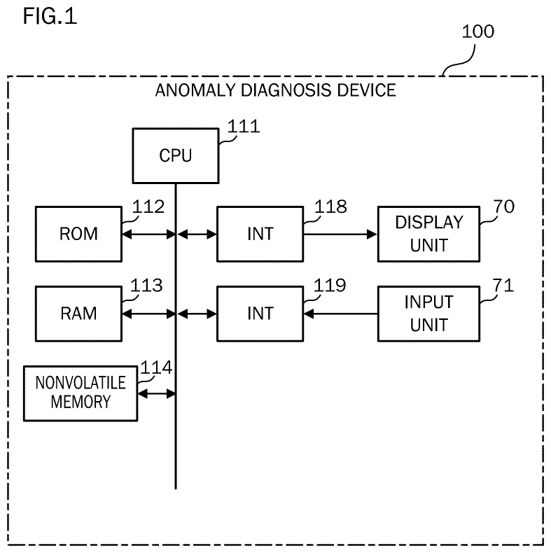

The hardware configuration of the anomaly diagnosis device 100 of the present disclosure will be described with reference to FIG. 1.

The anomaly diagnosis device 100 is an information processing device such as a device that detects an anomaly in a facility and a machine of a factory provided inside the factory, a personal computer (PC) that monitors the state of a factory, or a numerical control device that monitors the state of a machine tool.

A CPU 111 of the anomaly diagnosis device 100 is a processor that controls the anomaly diagnosis device 100 as a whole. The CPU 111 reads a modified system program to a ROM 112 via a bus and controls the overall anomaly diagnosis device 100 in accordance with the system program. A RAM 113 temporarily stores temporary calculation data or display data, various data input by a user via an input unit 71, or the like.

A display unit 70 is a monitor attached to the anomaly diagnosis device 100 or the like. The display unit 70 displays an operation window, a setup window, or the like of the anomaly diagnosis device 100.

The input unit 71 is a keyboard, a touch panel, or the like integrated with the display unit 70 or separated from the display unit 70. The input unit 71 may accept a user's entry to a window displayed on the display unit 70 or the like. Note that the display unit 70 and the input unit 71 may also be those of a mobile terminal.

A nonvolatile memory 114 is a memory backed up by a battery (not illustrated) or the like, for example, and the storage state thereof is held even when the anomaly diagnosis device 100 is powered off. The nonvolatile memory 114 stores a program loaded from an external device via an interface (not illustrated), a program input via the input unit 71, or various data acquired from each unit of the anomaly diagnosis device 100 or sensors in a factory. The program or various data stored in the nonvolatile memory 114 may be loaded into the RAM 113 during execution/during use. Further, various system programs are written in the ROM 112 in advance.

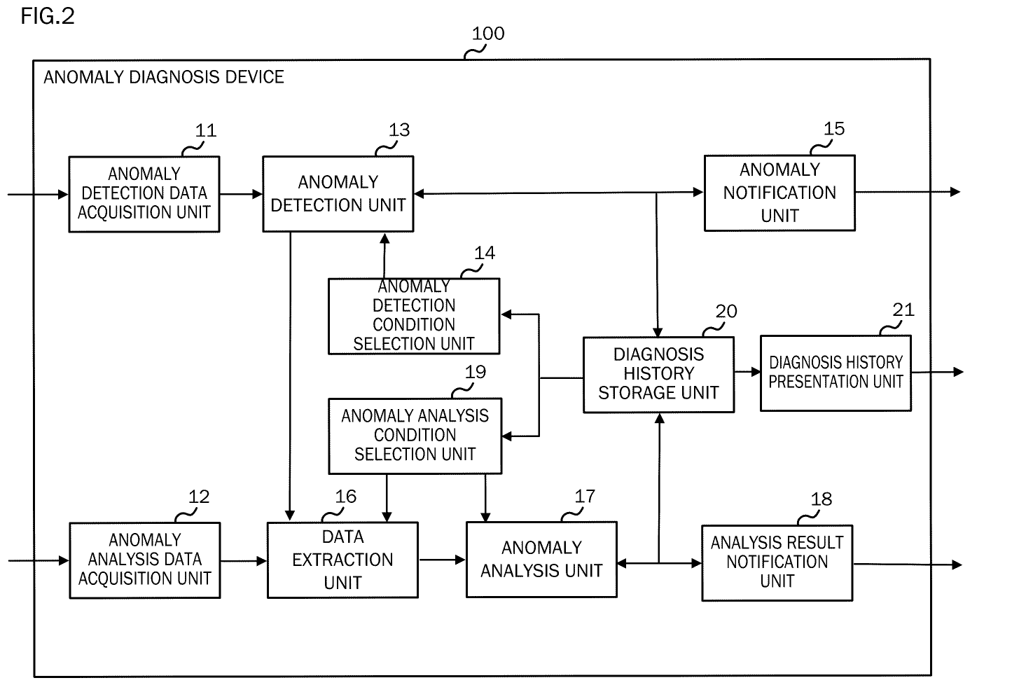

FIG. 2 is a block diagram of the anomaly diagnosis device 100 of the first disclosure.

The anomaly diagnosis device 100 includes an anomaly detection data acquisition unit 11, an anomaly analysis data acquisition unit 12, an anomaly detection unit 13, an anomaly detection condition selection unit 14, an anomaly notification unit 15, a data extraction unit 16, an anomaly analysis unit 17, an analysis result notification unit 18, an anomaly analysis condition selection unit 19, a diagnosis history storage unit 20, and a diagnosis history presentation unit 21.

The anomaly detection data acquisition unit 11 acquires data to be used for anomaly detection. The data to be used for anomaly detection is selected by the anomaly detection condition selection unit 14 described later. The data acquired by the anomaly detection data acquisition unit 11 may be operational data from a control device such as a numerical control device or a PLC and sensor data detected by a sensor provided in a factory, an internal sensor of an industrial machine including a machine tool, or the like.

The anomaly analysis data acquisition unit 12 acquires data to be used for anomaly analysis. The data to be used for anomaly analysis is selected by the anomaly analysis condition selection unit 19 described later. The data acquired by the anomaly analysis data acquisition unit 12 may be operational data from a control device such as a numerical control device or a PLC and sensor data detected by a sensor provided in a factory, an internal sensor of an industrial machine including a machine tool, or the like. Note that the data to be used for anomaly detection acquired by the anomaly detection data acquisition unit 11 is also included in the anomaly analysis data.

The anomaly detection unit 13 detects an anomaly by using data acquired by the anomaly detection data acquisition unit 11. The data to be used for anomaly detection is time-series data on motor torque, vibration, a temperature, a pressure, or the like. The anomaly detection is performed in real time.

In a normal state, the anomaly detection unit 13 determines whether or not there is an anomaly in anomaly detection data or calculates the degree of abnormality. In the detection of whether or not there is an anomaly and calculation of the degree of abnormality, it is desirable to calculate a feature of the data used for anomaly analysis associated with the occurrence of the anomaly. The feature is calculated from motor torque, vibration, a control signal, or the like. The feature may be an extracted section of each data, statistics (a root mean square (RMS), a maximum, a minimum, a standard deviation, a skewness, a kurtosis), a value of a frequency region after subjected to Fourier transformation (a power spectral density (PSD), an amplification at each frequency, a phase), or the like.

The feature is not determined in advance but is selected from normal data and abnormal data from the perspective of compatibility or universality. Some feature candidates are selected in advance and then evaluated for the compatibility or universality of the feature based on a certain criterion, and an optimal feature is determined by repetition of the above.

Herein, the compatibility means a feature associated with the largest separation between the normal data and the abnormal data. Further, a combination of such features is also included.

With respect to the universality, digital signals have higher universality than analog signals in terms of noise tolerance, portability, or the like, for example. Further, velocity signals have higher universality than torque commands, and control signals have higher universality than velocity signals in terms of easier data acquisition.

The anomaly notification unit 15 may have a function to notify the operator of a feature amount of anomaly analysis data.

The anomaly detection unit 13 may have a function to calculate the degree of abnormality based on a feature of anomaly analysis data. The anomaly notification unit 15 notifies the operator of the degree of abnormality of the anomaly analysis data calculated by the anomaly detection unit 13. The operator may confirm the degrees of abnormality of multiple types of data.

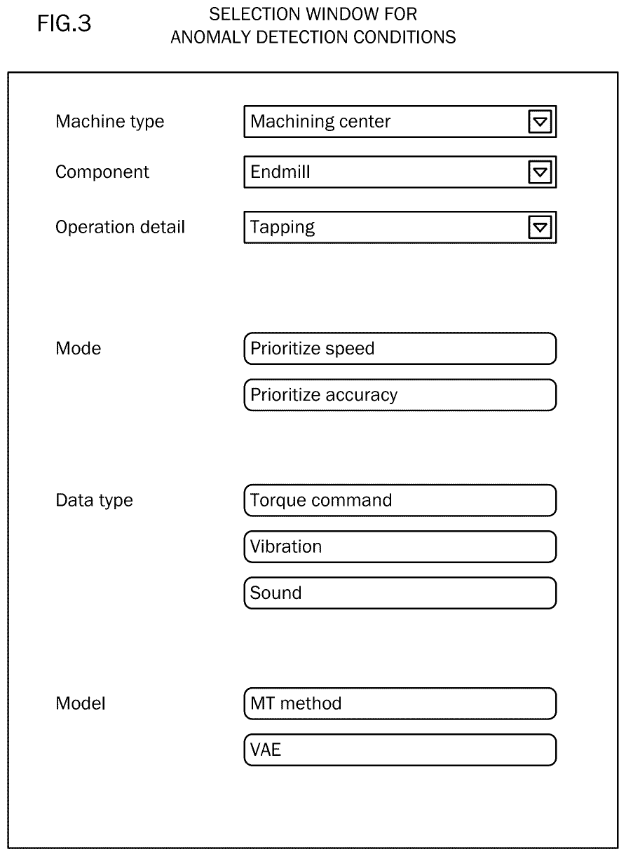

The anomaly detection condition selection unit 14 accepts selection of anomaly detection conditions from the operator. FIG. 3 is an example of a selection window for anomaly detection conditions. On the selection window for anomaly detection conditions, it is possible to input the type of a machine or a facility, a component to be used, setup information on a machine or a facility, an operation detail of a machine or a facility, a mode of anomaly detection, the type of data to be used for anomaly detection, a model to be used for anomaly detection, or the like.

On the selection window for anomaly detection conditions of FIG. 3, it is possible to input conditions such as “machining center” as the type of a machine tool, “endmill” as the component to be used, “tapping” as the operation detail, or the like.

The mode of anomaly detection may be “prioritize accuracy”, “prioritize speed”, and the like. As a result of selecting the mode of anomaly, a model of anomaly detection and a type of data to be used for anomaly detection that are suitable for the selected mode are determined.

The type of data to be used for anomaly detection may be current and a voltage, a temperature, a humidity, an infrared ray, an acceleration, a magnetism, a pressure, an inclination, a fluid velocity, vibration, a rotational speed, torque, or the like.

For example, when an anomaly of a motor and a mobile part driven by the motor is detected, data such as a torque command, vibration, sound, or the like are used.

As a result of selecting mode to prioritize speed, a single type or few types of data (for example, a torque command) is selected and a model uses the selected data to detect an anomaly. To increase the accuracy, not only a torque command but also multiple types or many types of data in combination is selected and a mode uses the selected data to detect anomaly.

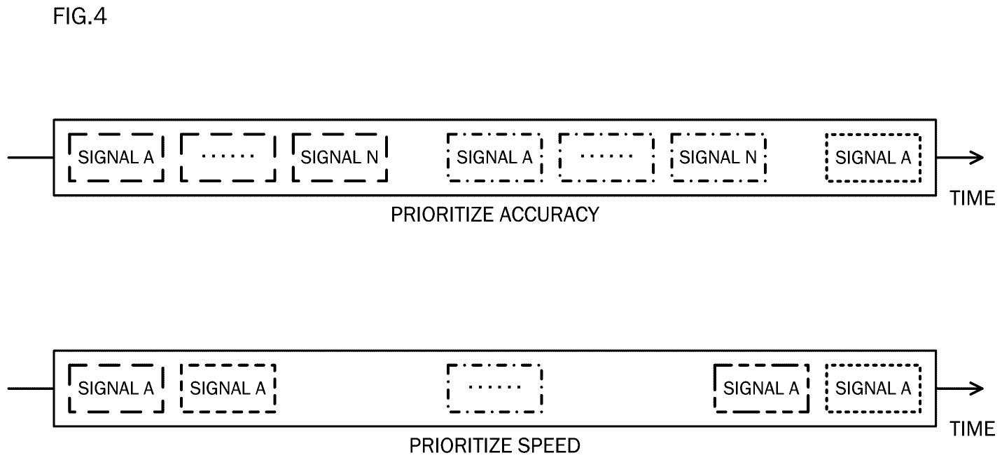

FIG. 4 illustrates a difference in the data quantity between the “prioritize accuracy” and the “prioritize speed”. In the signal processing in the “prioritize accuracy” to process multiple types of data, a plurality of signals (signal A to signal N) are input on a time block basis. In the signal processing in the “prioritize speed”, a single signal (signal A) is input on a time block basis. The anomaly detection unit 13 sequentially processes input data, and the process is faster when the data quantity is smaller.

The model of anomaly detection may be of an MAHARANOBIS-TAGUCHI method, a variational auto-encoder (VAE), or the like.

The MAHARANOBIS-TAGUCHI method is a method of quantifying whether or not a target is within a criterion when normal data is used as the criterion. MAHARANOBIS-TAGUCHI method calculates the degree of abnormality by using a mean value, a standard deviation, or the like. Such method involves a lower computational load.

The variational auto-encoder is one of the models using deep learning. Although the accuracy is improved when a large amount of suitably prepared data is available, the computational load is high.

As a result of selecting a mode to prioritize speed, a model with a lower computational load, such as the MAHARANOBIS-TAGUCHI method, is selected. As a result of selecting a mode to prioritize accuracy, a model with a higher computational load but with a relatively higher accuracy, such as the VAE, is selected.

The model to be used for anomaly detection can also be selected directly by the operator. In the selection window of FIG. 3, selection areas for the model to be used for anomaly detection and the type of data to be used for anomaly detection are provided.

The change in the condition of anomaly detection results in a different feature of the waveform and a different tendency of the waveform. The anomaly detection unit 13 and the anomaly analysis unit 17 store results of anomaly detection and anomaly analysis in the diagnosis history storage unit 20. Further, the diagnosis history storage unit 20 stores models on a condition basis that are trained and created in advance.

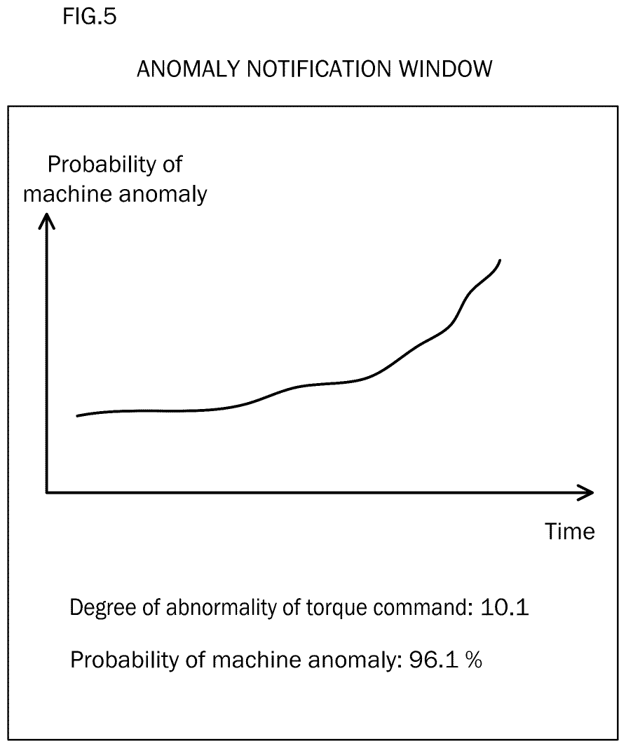

The anomaly notification unit 15 monitors anomaly detection data and, in response to detection of an anomaly, notifies the operator of the anomaly. FIG. 5 is an example of the anomaly notification window. In this window, the degree of abnormality of data to be used for anomaly detection (herein, a torque command), namely, “degree of abnormality of torque command: 10.1” and the anomaly probability for the degree of abnormality, namely, “probability of machine anomaly: 96.1%” are displayed. The graph of FIG. 5 illustrates the change in the probability of machine anomaly. The anomaly notification window is always displayed. The operator may confirm the result of anomaly detection in real time.

Once an anomaly occurs, the anomaly notification unit 15 displays the degree of abnormality of anomaly analysis data on the anomaly notification window. The operator may analyze the factor of the anomaly based on the degree of abnormality of multiple types of data.

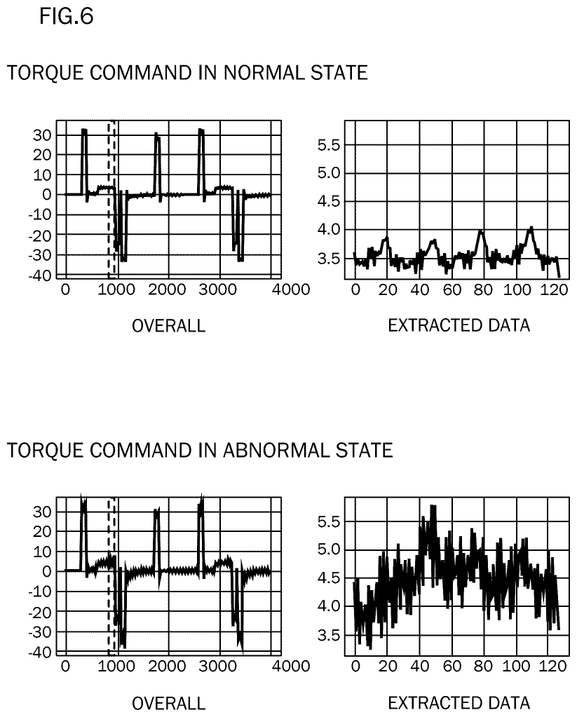

The data extraction unit 16 extracts data based on the result of anomaly detection. In FIG. 6, the torque command of a motor in a normal state is illustrated in the upper graphs, and the torque command of the motor in an abnormal state is illustrated in the lower graphs. Each region between the dotted lines in the graphs illustrates a range to be extracted. The range to be extracted is determined by a predetermined rule. As an example, the data is extracted from predetermined period before and after detection of anomaly. The rule for extraction is not particularly limited. It is found from FIG. 6 that the waveforms of the extracted data significantly differ between the normal state and the abnormal state.

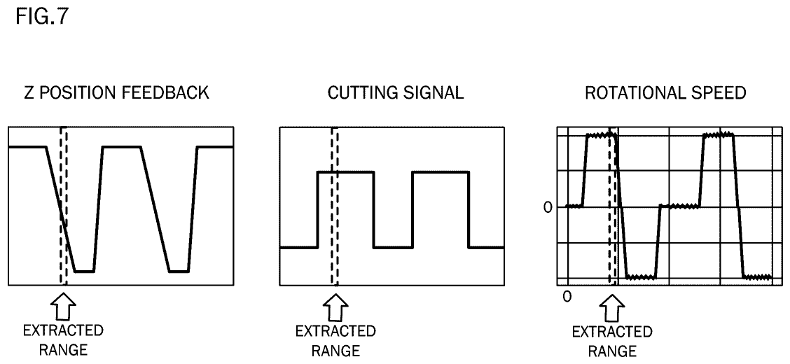

The data extraction unit 16 also extracts data to be used for anomaly analysis based on the result of anomaly detection. FIG. 7 illustrates extracted ranges of the Z-axis position feedback, the cutting signal, and the rotational speed. The data extraction unit also extracts other data based on the result of anomaly detection.

The anomaly analysis unit 17 acquires data extracted by the data extraction unit 16 and performs analysis on the factor of an anomaly. The diagnosis history storage unit 20 stores a model used for anomaly analysis generated from the past extracted data. The anomaly analysis unit 17 uses the model to analyze the factor of the anomaly from the extracted data.

The analysis result notification unit 18 notifies the operator of a result of anomaly analysis. FIG. 8 illustrates an example of a display window of an analysis result of the factor of an anomaly. The display window of FIG. 8 indicates an analysis result by probability such as “probability of tool breakage: 91.1%”, “probability of chips stuck: 6%”, “probability of lack of spindle grease: 2%”, “probability of spindle failure: 0.1%”, and “probability of incorrect sequence number: 0.001%”.

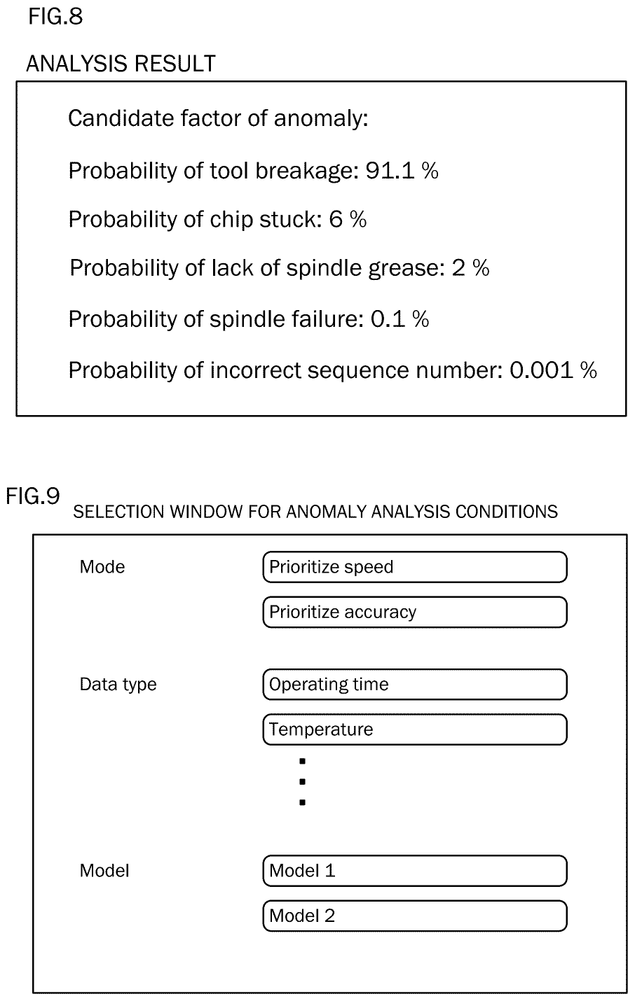

The anomaly analysis condition selection unit 19 accepts selection of anomaly analysis conditions from the operator. Setup of the anomaly analysis condition makes it possible to select a suitable model. FIG. 9 is an example of a selection window for anomaly analysis conditions. On the selection window, it is possible to select a mode of anomaly analysis, a type of data to be used for anomaly analysis, a model to be used for anomaly analysis, and the like.

The diagnosis history storage unit 20 stores conditions for anomaly detection, results of anomaly detection, extracted data, conditions for anomaly analysis, results of anomaly analysis, models used for anomaly detection, models used for anomaly analysis, or the like. The past diagnosis history is used for model building, anomaly detection, or anomaly analysis.

The diagnosis history presentation unit 21 presents the past diagnosis history stored in the diagnosis history storage unit 20 to the operator. The past diagnosis history can be used as supportive information for selecting the condition of anomaly detection and the condition of anomaly analysis. The past diagnosis history helps the selection of a model or a type of data for anomaly detection or anomaly analysis.

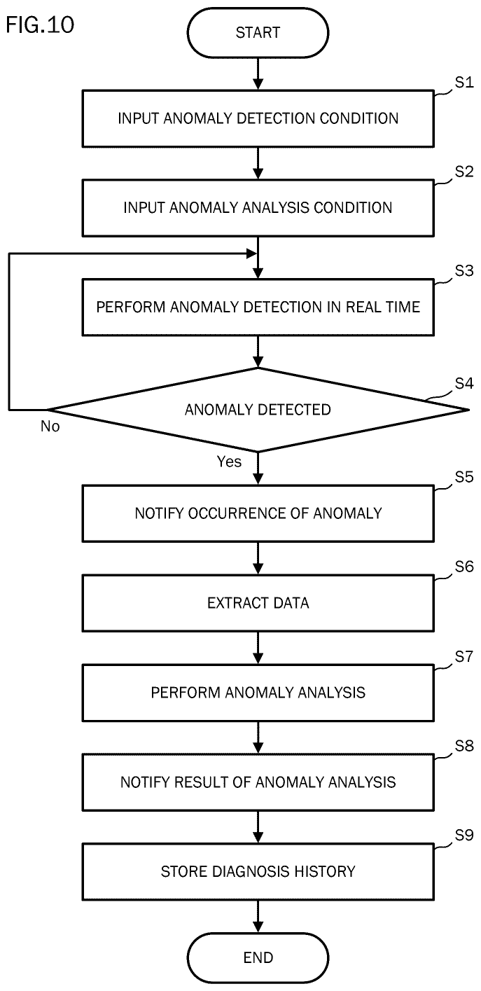

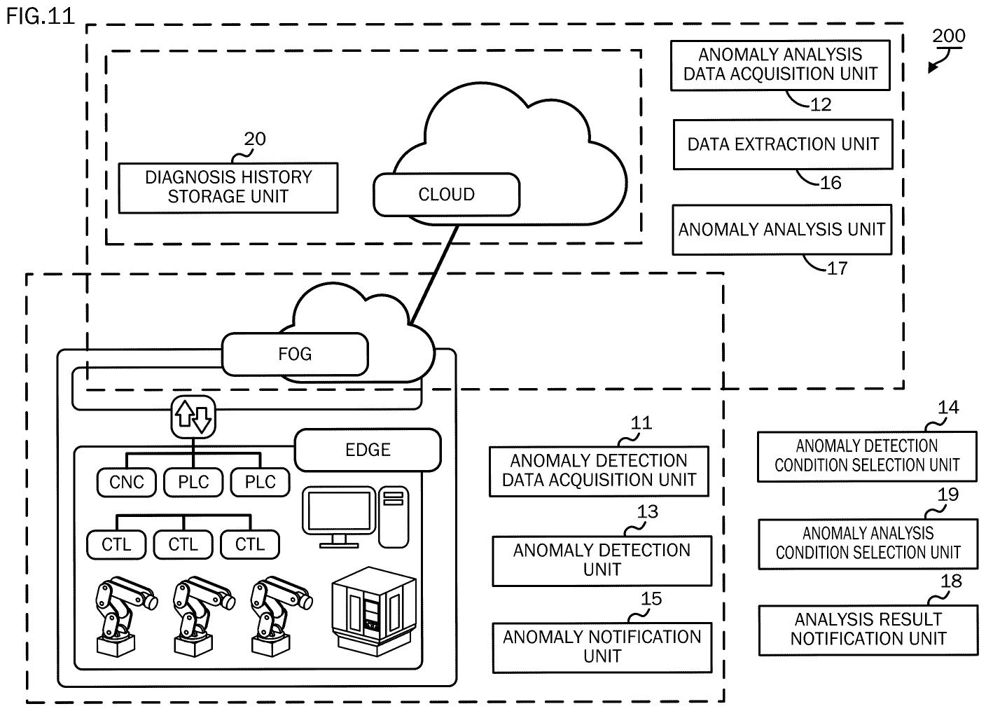

The operation of the anomaly diagnosis device 100 of the first disclosure will be described with reference to the flowchart of FIG. 10.

The anomaly diagnosis device 100 acquires an anomaly detection condition from the operator (step S1). For example, the anomaly diagnosis device 100 displays a selection window for anomaly detection conditions and accepts operator input. On the selection window, a mode of anomaly detection, a type of data to be used for anomaly detection, a model to be used for anomaly detection, or the like can be selected.

The anomaly diagnosis device 100 acquires an anomaly analysis condition from the operator (step S2). For example, the anomaly diagnosis device 100 displays a selection window and accepts operator input for anomaly analysis conditions. On the selection window, a mode of anomaly analysis, a type of data to be used for anomaly analysis, a model to be used for anomaly analysis, or the like can be selected. Note that processing order is changeable, so that the anomaly analysis condition may be selected before anomaly analysis of step S7.

The anomaly diagnosis device 100 acquires data from a facility or a machine of a factory and sensors arranged in the factory. The anomaly diagnosis device 100 performs anomaly detection under the condition selected in step S1 (step S3). The anomaly detection of step S3 is performed in real time, the number of data type used in anomaly detection is fewer than that in the anomaly analysis.

If occurrence of an anomaly is detected (step S4; Yes), the anomaly diagnosis device 100 notifies the operator of the occurrence of the anomaly (step S5). For example, the anomaly diagnosis device 100 displays an anomaly notification window and displays the degree of abnormality of target data that is used for the anomaly detection and the probability of the anomaly occurring.

If no occurrence of an anomaly is detected (step S4; No), the process proceeds to step S3 to continue the anomaly detection.

In response to detection of an anomaly, the anomaly diagnosis device 100 extracts data to be used for analysis of the anomaly (step S6). The type of data to be used for anomaly analysis has been selected in step S2. The data extraction range is determined by a predetermined rule.

The anomaly diagnosis device 100 uses the extracted data to perform anomaly analysis under the condition selected in step S2 (step S7). The anomaly analysis of step S7 is not required to be performed in real time. More types of data than in the anomaly detection of step S3 are used to estimate the site of the anomaly occurring, the factor of the anomaly, or the like.

The anomaly diagnosis device 100 notifies the operator of the result of the anomaly analysis (step S8). For example, the anomaly diagnosis device 100 displays the result of the anomaly analysis on a display window. In the display window, estimated factors and probabilities of the anomaly are displayed. The operator references the result of the anomaly analysis to identify the actual factor of the anomaly. The result confirmed by the operator is fed back to the anomaly diagnosis device as the true factor of the anomaly.

The anomaly diagnosis device 100 stores the condition of the anomaly detection, the model used for the anomaly detection, the result of the anomaly detection, the extracted data, the condition of the anomaly analysis, the result of the anomaly analysis, the model used for the anomaly analysis, the true factor of the anomaly fed back by the operator, and the like in the diagnosis history storage unit (step S9).

As described above, in the anomaly diagnosis device 100 of the first disclosure, anomaly diagnosis is divided into two stages of anomaly detection and anomaly analysis. A model used for anomaly detection requires fewer data and lower computational load than the model for anomaly analysis. This reduces the load in data acquisition or a computational load in the anomaly detection and makes it possible to perform the anomaly detection without delay.

The anomaly diagnosis device 100 of the first and second disclosure holds a plurality of models by which the factor of an anomaly can be identified. When an anomaly occurs, the anomaly diagnosis device 100 extracted anomaly diagnosis data in a period before and after the anomaly occurs, calculates the degree of separation from data in the normal state, respectively, and thereby identifies the factor of the anomaly.

The condition of anomaly analysis can be set by the operator. The operator is able to set a suitable diagnosis method while taking a computational load, a communication load, priority of accuracy and speed, or the like into consideration. According to the present disclosure, the productivity and the reliability of a factory improve while suppressing the computational cost, the communication cost, or the like.

The anomaly diagnosis device 100 displays a result of anomaly detection, i.e., the degree of abnormality in real time. The operator is able to monitor the change in the degree of abnormality and predict occurrence of an anomaly.

The anomaly diagnosis device 100 stores conditions of anomaly detection, results of anomaly detection, estimation accuracy of anomaly detection, conditions of anomaly analysis, results of anomaly analysis, estimation accuracy of anomaly analysis, and extracted data. The operator is able to select a suitable model based on the estimation accuracy of the past anomaly diagnosis or the like.

### Second Disclosure

The second disclosure will be described. An anomaly diagnosis system 200 of the second disclosure is such that the components in the anomaly diagnosis device of the first disclosure are arranged in a distributed manner in a factory system. FIG. 11 is an example of the factory system. As illustrated in FIG. 11, the factory system is formed of an edge, a fog, and a cloud.

The edge is a region close to sensors or control devices in network. In the edge computing, real-time processing is performed on a large amount of data obtained from a large number of sensors arranged in a factory or control devices of facilities or machines in a factory.

The cloud is not an internal hard drive or a local server but an external system accessible via the Internet. The cloud computing is to store a large amount of data collected by the edge in the cloud and perform analysis on the data.

The fog is located between the cloud and the edge in the network. The fog may perform data processing that would otherwise be performed in the cloud. Since data processing is performed prior to transmission over the Internet, quick adaptation to a change in the environment is made possible.

In the anomaly diagnosis system 200 of the second disclosure, the anomaly detection data acquisition unit 11 and the anomaly detection unit 13 are implemented on the edge or the fog. Specifically, the anomaly detection data acquisition unit 11 and the anomaly notification unit 15 are implemented in an information processing device close to the edge in the network (for example, a numerical control device (computerized numerical control (CNC)), a PLC, a local server), an information processing device close to the fog in the network (for example, a gateway), or the like.

The anomaly analysis data acquisition unit 12, the data extraction unit 16, and the anomaly analysis unit 17 are implemented in an information processing device on the cloud or an information processing device close to the fog. The diagnosis history storage unit 20 is implemented on a storage device on the cloud.

The anomaly detection condition selection unit 14, anomaly analysis condition selection unit 19, and the analysis result notification unit 18 may be implemented in any of the edge, the fog, and the cloud.

In the anomaly diagnosis system 200 of the second disclosure, anomaly detection is performed in the information processing device close to the edge or the fog, and anomaly analysis is performed in the information processing device close to the fog or performed over the cloud. In the anomaly diagnosis system, it is possible to select an anomaly detection condition and an anomaly analysis condition in advance and set a suitable anomaly diagnosis method while taking a computational load, a communication load, priority of accuracy and speed, or the like into consideration.

In the anomaly diagnosis system, anomaly detection can be performed in the edge or the fog in real time, and analysis of data in which an anomaly is detected can be performed in the fog or over the cloud.

1. An anomaly diagnosis device that is designed to diagnose anomalies occurring a factory, the anomaly diagnosis device comprising:
an anomaly detection data acquisition unit that acquires data to be used for anomaly detection;
an anomaly detection unit that uses the data acquired by the anomaly detection data acquisition unit to detect an anomaly to be diagnosed;
an anomaly notification unit that notifies the anomaly detected by the anomaly detection unit;
an anomaly analysis data acquisition unit that acquires data to be used for anomaly analysis; and
an anomaly analysis unit that uses the data to be used for the anomaly analysis obtained in a period including a time of occurrence of the anomaly or uses the data to be used for the anomaly detection and the data to be used for the anomaly analysis obtained in a period including a time of detection of the anomaly to analyze a candidate factor of the anomaly.

2. The anomaly diagnosis device according to claim 1,
wherein the anomaly detection unit identifies feature of data associated with an anomaly based on data in a normal state and an abnormal state, and
wherein the anomaly notification unit notifies the feature.

3. The anomaly diagnosis device according to claim 2,
wherein the anomaly detection unit determines a degree of abnormality for each feature, and
wherein the anomaly notification unit notifies a feature for which the degree of abnormality is high.

4. The anomaly diagnosis device according to claim 1 further comprising an anomaly detection condition selection unit that accepts selection of data to be used for the anomaly detection and an anomaly detection condition to be used for the anomaly detection.

5. The anomaly diagnosis device according to claim 1 further comprising an anomaly analysis condition selection unit that accepts selection of data to be used for the anomaly analysis and an anomaly analysis condition to be used for the anomaly analysis.

6. The anomaly diagnosis device according to claim 3, wherein the anomaly detection condition selection unit accepts selection as to whether the anomaly detection is to prioritize accuracy or prioritize speed and, based on the selection, determines data to be used for the anomaly detection and a model to be used for the anomaly detection.

7. The anomaly diagnosis device according to claim 1, wherein the anomaly notification unit notifies a degree of abnormality of the data to be used for the anomaly detection in real time.

8. The anomaly diagnosis device according to claim 1 further comprising:
a diagnosis history storage unit that stores a result of anomaly diagnosis; and
a diagnosis history presentation unit that presents the result of anomaly diagnosis.

9. An anomaly diagnosis system that is designed to diagnose anomalies occurring in a factory, the anomaly diagnosis system comprising:
an anomaly detection data acquisition unit that acquires data to be used for anomaly detection;
an anomaly detection unit that uses the data acquired by the anomaly detection data acquisition unit to detect an anomaly to be diagnosed;
an anomaly notification unit that notifies the anomaly detected by the anomaly detection unit;
an anomaly analysis data acquisition unit that acquires data to be used for anomaly analysis; and
an anomaly analysis unit that uses the data to be used for the anomaly analysis obtained in a period including a time of occurrence of the anomaly or uses the data to be used for the anomaly detection and the data to be used for the anomaly analysis obtained in a period including a time of detection of the anomaly to analyze a candidate factor of the anomaly.

10. A storage medium storing a computer readable instruction that causes one or a plurality of processors to:
acquire data to be used for anomaly detection for an anomaly occurring in a factory;
use the data to be used for anomaly detection to detect an anomaly to be diagnosed;
notify the detected anomaly;
acquire data to be used for anomaly analysis; and
use the data to be used for the anomaly analysis obtained in a period including a time of occurrence of the anomaly or uses the data to be used for the anomaly detection and the data to be used for the anomaly analysis obtained in a period including a time of detection of the anomaly to analyze a candidate factor of the anomaly.
